(19) United States
(12) Patent Application Publication
(10) Pub. No.: US 2012/0112688 A1
(43) Pub. Date: May 10, 2012

(54) Battery Module with Less Charging Time and Charging Method of the Same

(75) Inventor: Chang-Yu Ho, Hsinchu County (TW)

(73) Assignee: NEOTEC SEMICONDUCTOR LTD., Hsin-Chu Hsien (TW)

(21) Appl. No.: 13/288,188

(22) Filed: Nov. 3, 2011

(30) Foreign Application Priority Data
Nov. 5, 2010 (TW) 99138271

(51) Int. Cl. H02J 7/00

(52) U.S. Cl. 320/107; 320/162; 320/157; 320/128

(57) ABSTRACT

The battery module comprises a main battery, a voltage converter, an auxiliary device, a battery management unit and a first set of switching devices and a second set of switching devices. The main battery provides the electric power. The auxiliary device is used to store the electric power. The battery management unit controls the main battery and the auxiliary device to charge or discharge through a first set of switching devices and a second set of switching devices, respectively. When the battery module is charged by an external charger, the auxiliary device and the main battery are charged simultaneously. When the external charger stops to charge the battery module, the battery management unit controls the auxiliary device through the second set of switching devices to continuously charge the main battery through the voltage converter.

### FIELD OF THE INVENTION

The present invention is related to a battery module, especially to a battery module which can reduce waiting time for charging and promote the safety of charging and discharging.

### BACKGROUND OF THE INVENTION

Nowadays, since the price of the fuel is raising and the global warming is becoming severe, the policy for energy saving and carbon emission reduction get more concern for the governments all over the world. The hybrid-electric vehicles, electrical vehicles or electrical car become more and more popular. It is necessary for these “electrical” vehicles to include a battery with large capacity or a battery module consisting of a plurality of battery connected in series or in parallel. This sort of battery only can be charged in an outdoor charging station or by the charger, which is very different to the batteries of the automobile and the diesel vehicle, because the later are charged by the turbine connected with the belt or drive component driven by the diesel engine. In addition, because the battery is the main and only one power supply of the electrical vehicle, the required electrical capacity must reach ten to hundred times of the capacity of the battery applied in a laptop, which has the capacity about 4 AH, and then the consumers will accept it. However, the large capacity means that it needs more time to charge the battery module, which is another reason why the customers do not choose the electrical vehicle.

Please refer to the FIG. 1, which shows the charger 120 and the structure of the battery module 100 in the prior art. The battery module 100 comprises a plurality of cell arranged in series or/and in parallel, hereafter called main battery, a battery management unit (BMU), and a signal bus 150. When the battery module 100 is charged, the charger 120 receives the charging voltage and the charging current data from the battery management unit (BMU) through the signal bus 150. In addition, the external charging protection switch 115 and the discharging protection switch 116 are controlled by the overcharging detecting circuit, a discharging detecting circuit (not shown in the FIG. 1) and some logic circuits (not shown in the FIG. 1) in BMU through two pins CO and DO respectively. The external fuse 117 is controlled by the over-current detection circuit (not shown in the FIG. 1).

When the charger 120 charges the main battery 110, the anode and cathode of the charger 120 are connected with that of the main battery 110. Specifically, the charger 120 charges the main battery 110 through the fuse 117, the charging and discharging protection switches 115, 116, which are arranged in series between the anodes of the charger 120 and the main battery 110.

In the prior art, the charging method includes constant current charging mode (CC charging mode) and constant voltage charging mode (CV charging mode). The battery module 100 is charged usually with both the CC and CV charging mode. That is, the battery module 100 is charged first in the CC charging mode (CC mode), then is charged in the CV charging mode (CV mode). Please refer to the FIG. 2A, which shows the charging voltage and the charging current during the whole charging process. As shown in FIG. 2A, it is clear that 70% of the capacity of the battery module can be reached in the CC charging mode, and the rest 30% is completed in the CV charging mode. Since it takes less time to charge the battery module in the CC charging mode than in the CV charging mode, the time efficiency in the CC charging mode is obviously much higher than that in the CV charging mode.

Please refer to the FIG. 2B, which shows another embodiment in the prior art. When the battery manager unit detects the voltage of the main battery module 210 is lower than a predetermined value, for example about less than 2.5V for Lithium battery, the main battery module 210 is charged with a smaller constant current, for example about 0.1 C. When the voltage is higher than the full charge voltage, the main battery module 210 is charged with higher constant current, for example about 0.7 C.

The second embodiment in the prior is shown in FIG. 2B. For saving the charging time, the main battery module 110 is charged with the larger constant current, for example about 1.0 C in a first stage. When the voltage of the battery module 110 gets reach to a predetermined value, it is then charged with a smaller constant current, about 0.7 C, in a second stage.

No matter using which one CC charging mode as above in the beginning, it usually takes much time to charge the battery in the sequentially CV charging mode, especially for the electrical vehicles, because their battery module has high capacity. The owner needs to spend more much time to wait for charging their vehicles. Therefore, it is a significant challenge how to reduce the waiting time in the charging station for every owner.

As aforementioned, an object of the present invention is to disclose a new battery module. This battery module is capable of significantly reducing the waiting time, providing a larger transient operating current, and having the better charging and discharging safety.

### BRIEF SUMMARY OF THE INVENTION

A battery module with a less charging time is disclosed in the present invention. The battery module comprises a main battery, a voltage converter, an auxiliary device, a battery management unit and a first set of switching devices and a second set of switching devices. The main battery provides a load with the electric power. The auxiliary device is used to store the electric power. The battery management unit controls the main battery and the auxiliary device to charge or discharge through a first set of switching devices and a second set of switching devices, respectively. Wherein, when the battery module is charged by an external charger, the auxiliary device and the main battery are charged simultaneously. When the external charger stops to charge the battery module, the battery management unit controls the auxiliary device through the second set of switching devices to continuously charge the main battery through the voltage converter, for instance, in the CV charging mode.

In addition, the auxiliary device can supply the electric power to the load together with the main battery through the voltage converter so as to raise the operating current of the load to accommodate the condition which needs to output a larger electric power.

In the other hand, The BMU in the present invention can correct the output voltage of the external charger for further protecting the main battery

The advantages and the spirits of the present invention will become apparent in the following descriptions taken in conjunction with the following drawings.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1 is a schematic representation of a battery module, external charger and loads of the prior art.

FIG. 2A shows when the battery module is charged in the CC charging mode initially, followed by the CV charging mode.

FIG. 2B shows the charging method of the prior art when the BMU detects the voltage of the main battery is too low.

FIG. 2C shows the BMU of the prior art provides another charging method with less time.

FIG. 3 shows the representation of the battery module of the present invention, which can reduce the waiting time in charging phase.

FIG. 4A shows after the external charger stop to charge, the auxiliary device of the present invention continue to charge the main battery in CC4 and CC5 charging mode.

FIG. 4B shows after the external charger stop to charge, the auxiliary device of the present invention continues to charge the main battery module in CC4 and CV2 charging mode.

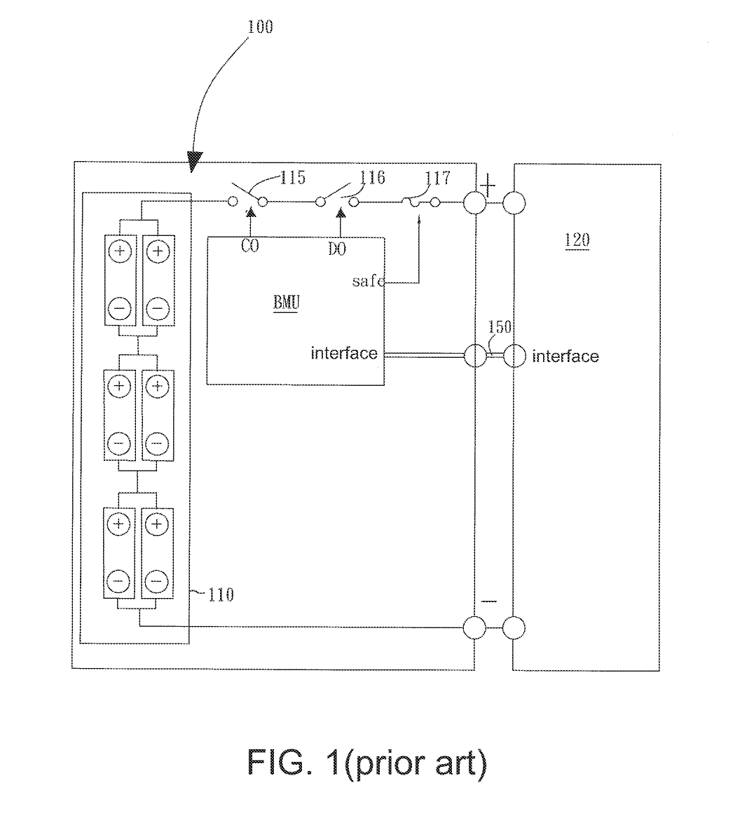

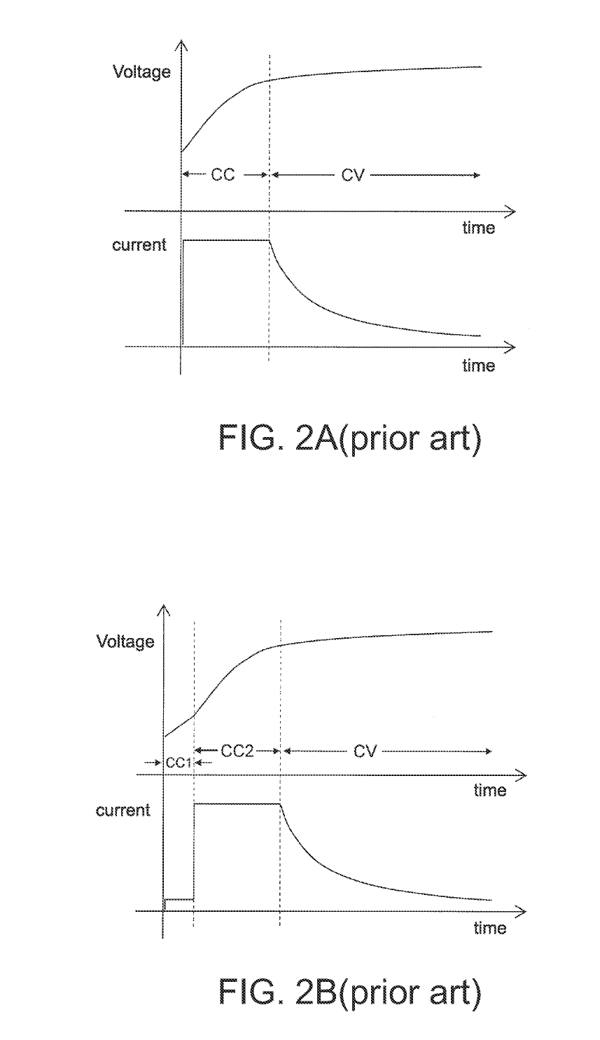

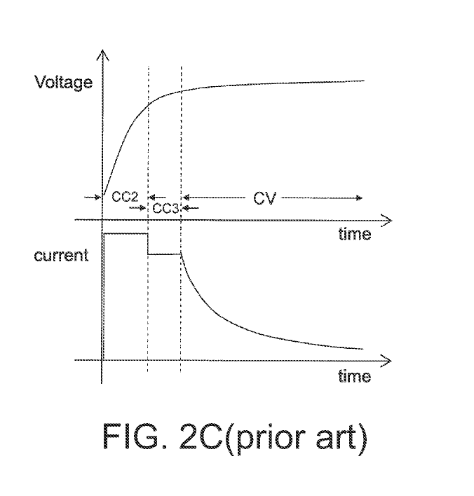

### DETAILED DESCRIPTION THE INVENTION

The battery module comprises a main battery 210, an auxiliary device 230, a voltage converter 240, a battery management unit, BMU, a first set of the switching device and a second set of the switching device. The main battery 210 is used to provide a load with the electric power can be a single high capacity battery or a set of cells connected in series or/and in parallel. The cell can be chosen from a lithium battery or a nickel metal hydride battery. The high capacity battery can be chosen from the lead-acid battery, the LiFePO₄ battery or the LiFeₓM_{y}PO_{z} battery and so on. Most of them are charged in the CC-CV mode. It takes more much charging time and has less electric energy charged in the CV stage than in the CC stage. The shortcoming can be solved by the present invention.

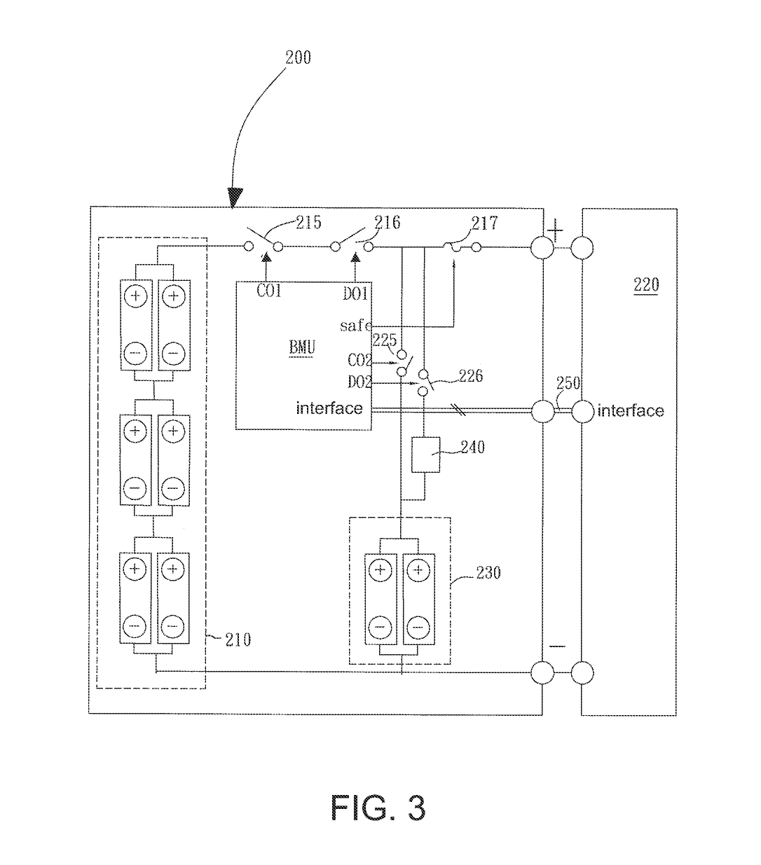

The auxiliary device 230 of the present invention is used to be charged and discharged, or store electric power. The auxiliary device 230 can be an independent battery, a capacitor or a super capacitor, and so on. In one embodiment, as shown in FIG. 3, the main battery 210 is a set of cells connected in series and in parallel. The auxiliary device 230 is a battery which has a plurality of cells connected in parallel. The representation in FIG. 3 is only for the convenience of the description, not a limitation of the main battery and the auxiliary device, since their types can be the same or different, for instance, larger or smaller, have no influence on the present invention.

The first set of switching devices and the second set of switching devices are connected with the BMU. The BMU controls the main battery 210 and the auxiliary device 230 to charge and discharge through the first set of switching devices and the second set of switching devices, respectively. The first set of switching devices comprises a charging protection switching 215 and a discharging protection switching 216. The second set of switching devices comprises a second charging protection switching 225 and a second discharging protection switching 226. The BMU has an over-current detecting circuit (not shown in the FIG. 3), an overcharging detecting circuit, a discharging detecting circuit, some logic circuits (not shown in the FIG. 3), and four pins CO1, DO1, CO2, and DO2. The over-current detecting circuit controls the external fuse 217. The other circuits through the pins CO1 and DO1 control the charging protection switch 215 and the discharging protection switch 216, respectively, similarly, through the pins CO2 and DO2 control the second charging 225 and the second discharging protection switch 226, respectively. Therefore, when the main battery 210 is charged by the external charger 220, the BMU can control the auxiliary device 230 to be charged and discharged simultaneously through the second set of switching devices. When the external charger 220 stops to charge the battery module 200, the BMU controls the auxiliary device 230 through the second set of the switching devices to continuously charge the main battery 210 in the CV charging mode or in the CC charging mode. At the same time, the voltage convertor 240 is used to raise the voltage level of the auxiliary device 230. The consistence of the BMU, the auxiliary device 230, the converter is like an internal charger of the battery module 200.

As aforesaid, charge in the CC charging mode quite meets the economic effect. Therefore, the auxiliary device 230 and the main battery 210 are charged at the same time in the CC charging mode. Since the BMU through pins, CO2 and DO2 controls the second charging and the discharging switches 225, 226, the charging and discharging of the auxiliary device 230 is independently controlled by the BMU. In one preferred embodiment, the auxiliary device 230 is battery with smaller capacity, consisting of a set of the cells. Accordingly, while the main battery 210 is still charged in the CC charging mode, the auxiliary device 230 has been charged from the CC charging mode to the CV charging mode. And the charging phase of the auxiliary device 230 is finished earlier than that of the main battery 210.

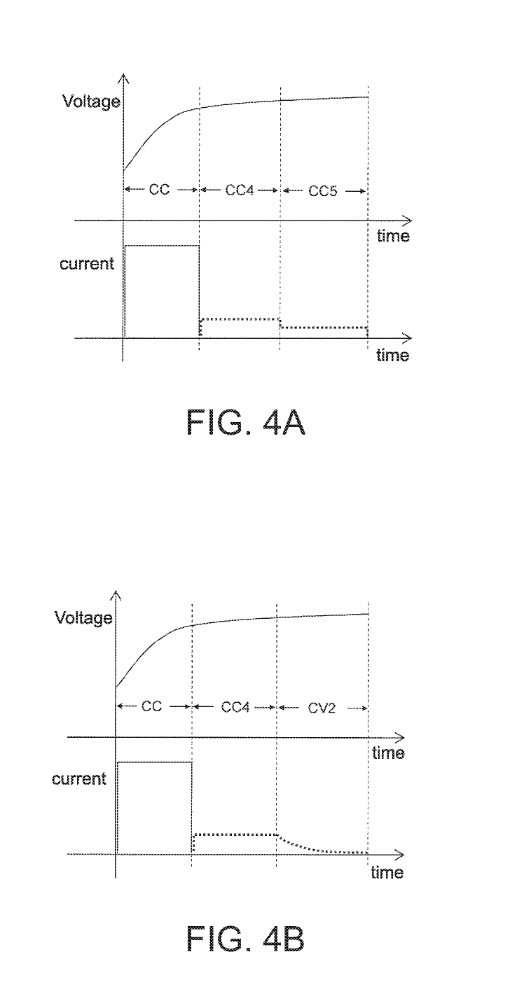

In one embodiment of the present invention, when the auxiliary device 230 is charged fully or nearly fully in the CC charging mode, or the CC charging mode of the main battery 210 is finished, the external charger 220 can stop to charge the battery module 200. Thus, the owner of the electric vehicle can leaves the outdoor charging station and needs not to wait for the charging phase of the main battery 210 to the finish. In one embodiment, when the external charger 220 stop to charge the battery module, the BMU can control the second charging and the discharging switch 225, 226 through these two pins, CO2 and DO2, respectively, to make the auxiliary device 230 continuously charge the main battery 210 in the CC4, CC5 mode, as described in FIG. 4A. In another embodiment, the main battery 210 is continuously charged by the auxiliary device 230 in the CC4 mode and the CV2 mode, as shown in the FIG. 4B.

The discharging voltage of the auxiliary device 230 in the present invention is boosted by the voltage converter 240 such as a charge pump circuit to be suitable for charging the main battery 210. Besides, the second charging and the discharging switches 225, 226 are controlled by the BMU through these independent pins, CO2 and CD2. Therefore, the combination of the abovementioned three devices makes the auxiliary device 230 being like a charger equipped with the vehicle. And the charge stored in the auxiliary device 230 can be discharged as completely as possible. The main battery 210 is charged in the CV charging mode, which still needs to take long time, but the owner's journey would not delay because the owner can drive his or her electrical vehicle, leaving the outdoor charging station. In addition, after charged in the CC charging mode, the main battery 210 can be for further charged by the auxiliary device 230 in the CV charging mode. The voltage of the main battery 210 can reach to a higher voltage level. The problem of the main battery in the prior art is either the charging time in the CV mode is too long or the charge is not enough, thereby to damage the activity of the internal materials in the main battery usually. Compared with the prior art, this problem can be solved in the present invention.

Also, the auxiliary device 230 of the present invention can discharge to the load together with the main battery 210 through the voltage converter 240.

When the battery module 200 equipped with the BMU, the charging voltage and the charging current of the battery module 200 are generally configured by the BMU. When the battery module 200 is charged, the external charger 220 outputs the voltage and the current according to these configured values. The value of the charging voltage and the charging current configured by the BMU is more reliable than that actually outputted from the external charger 220. Since the price war is become an implement in the market to defeat the competitor, the charger often becomes the primary object of the cost reduction. The products of higher price or high performance may be equipped with the charger having superior performance, however the products of lower price may be equipped with the inferior charger, whose quality may not be strictly required. And the output voltage from the cheaper charger is more inaccurate. For example, if the critical voltage set by the BMU is 4.2 V, the charger should output the same value, but, in fact, the real output voltage is often lower or higher than 4.2 V. For instance, the voltage outputted by the charger gets reach to 4.1 V, the charging mode of the battery module 220 has been switched to the CV charging mode. Another case is that the real output voltage gets reach to 4.3 V, more than the setting value of the BMU. Accordingly, the safety management of the battery module 200 has some problems.

If the real output voltage of the charger 220 is usually “higher” than the critical voltage, the BMU would usually detect an overcharging signal. If the frequency of detecting the overcharging signal by the BMU is more than a predetermined number, the BMU will alarm and automatically stop the charging procedure of the external charger. For example: burning out the fuse 217 or closing the charging and discharging loop system to stop charging and discharging for avoiding danger. In the present invention, the BMU requests the external charger 220 to lower the output voltage through the signal line between the battery module and the charger, or a signal bus 250 so as to avoid the real output voltage to be frequently higher than the critical voltage and improve the safety during charging.

Another case is that when the real output voltage is still smaller than the critical voltage, the main battery 210 has been charged by the external charger 220 in the CV charging mode. Thus, the BMU would detect a smaller output current than the setting charging current. To solve the problem and promote the charging efficiency, the BMU of the present invention will request the external charger 220 to raise the output voltage through the signal bus 250 so as to increase the output current.

The BMU of the present invention can also control the external charger 220 to lower the output voltage according to the aging condition of the battery module, i.e. the increasing number of times of charging and discharging, to improve the charging security. In a preferred embodiment, a charging time is predetermined by the BMU in the CC charging mode or in the CV charging mode, respectively. When real charging time is more than the predetermined charging time, the BMU stops the charging procedure. For example, the main battery 210 is charged in the CC charging mode, no matter in the CC1, CC2, or CC3 mode, when the charging time excesses the predetermined charging time, the BMU would switch off the charging protection switch 215 or/and the second charging protection switch 225 to stop the charging procedure, even though the voltage of the battery does not reach the voltage of the overcharging protection yet.

In addition, the BMU of the present invention can manage the charging power, the product of the voltage and the current. The charging power is predetermined by the BMU. When the charging power is over the predetermined value, no matter in CC or CV charging mode, the BMU turns off the charging switch to stop the charging procedure of the external charger 220.

There are many advantages in the present invention as following:
1. Although the auxiliary device provides the increment to the cost, the waiting time for charging the battery module of the electrical vehicle is obviously reduced for the owner. Especially for the electrical vehicle with the battery module having large capacity, only in the CC charging mode the main battery needs to be charged by the external charger, then the main battery can be charged continuously by the auxiliary device. In comparison with the prior art, when the main battery is charged in the CV charging mode, the owner does not need to wait in the outdoor charging station.
2. Although the charging time of the electrical vehicle in the outdoor charging station is saved, the activity of the internal materials in the main battery would not be damage.
3. The BMU in the present invention can correct the output voltage of the external charger for further protecting the main battery.
4. The auxiliary device can supply the electric power to the load together with the main battery through the voltage converter so as to raise the operating current of the load.

While the preferred embodiment of the invention has been illustrated and described, it will be appreciated that various changes and modifications can be made therein without departing from the spirit and scope of the invention.

What is the claimed is:

1. A battery module with a less charging time comprises:
a main battery for providing a load with the electric power;
a voltage converter;
an auxiliary device, for electric power storage;
a first set of switching devices and a second set of switching devices; and
a battery management unit, wherein said battery management unit control said main battery and said auxiliary device to charge or discharge through said first set of switching devices and said second set of switching devices, respectively; when said battery module is charged by an external charger, said auxiliary device and said main battery are charged simultaneously; when the external charger stop to charge said battery module, said battery management unit controls said auxiliary device through said second set of switching devices to continuously charge said main battery through said voltage converter.

2. The battery module according to claim 1, wherein said auxiliary device is selected from a super capacitor, or a battery.

3. The battery module according to claim 1, wherein said battery management unit detects the output voltage and the output current of the external charger to correct a predetermined charging voltage.

4. The battery module according to claim 1, wherein said auxiliary device is charged with a constant current by the external charger, when said auxiliary device is charged fully or nearly fully, the external charger can stop to charge said battery module.

5. The battery module according to claim 1, wherein said auxiliary device can supply the electric power to the load together with said main battery through said voltage converter so as to raise an operating current of the load.

6. A method for charging the battery module of claim 1 in less time, comprises:
using a external charger to charge said battery module, wherein said main battery and said auxiliary device are charged simultaneously;
removing said external charger; and
said battery management unit controlling said auxiliary device to continuously charge said main battery through said second set of switching devices and said voltage converter.

7. A method for rapid charging a battery module, wherein the battery module with more safety, the method comprises:
providing a battery module, wherein the battery module includes a main battery, a battery management unit, a first set of switching devices and a signal bus, wherein said battery management unit control said main battery to charge or discharge through said first set of switching devices;
determining an charging voltage or an charging current; and
detecting a real output voltage or a real output current of a external charger by said battery management unit, when the output voltage value or the real output voltage is different from said charging voltage or said charging current, said battery management unit corrects said the output voltage or output current value of the external charger through said signal bus.

8. The method for rapid charging a battery module according to claim 7, further comprises the steps of:
the battery management unit giving an alarm when the real output voltage is higher or lower than the charging voltage, or the real output current is higher or lower than the charging current; and
the battery management unit stopping the charging procedure of the external charger when the frequency of the alarm excesses a predetermined number.

9. The method for rapid charging a battery module according to claim 7, further comprises the steps of:
Determining a charging time in the CC charging mode or in the CV charging mode respectively;
the battery management unit stopping the charging procedure of the external charger when real charging time is more than said charging time.

10. The method for rapid charging a battery module according to claim 7, wherein said battery management unit lowering the charging voltage according to a increasing charging and discharging times of the main battery.
